(19) United States
(12) Patent Application Publication
(10) Pub. No.: US 2009/0112910 A1
(43) Pub. Date: Apr. 30, 2009

(54) METHOD AND APPARATUS FOR PERSONALIZATION OF AN APPLICATION

(75) Inventors: Jerome Picault, Paris (FR); Myriam Ribiere, Nozay (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/930,365

(22) Filed: Oct. 31, 2007

(51) Int. Cl. G06F 17/00

(52) U.S. Cl. 707/102; 707/E17.005

(57) ABSTRACT

The invention relates to personalizing an application such as a content search and retrieval application. An ontology store (301) provides a multi-user ontology for a plurality of users. The multi-user ontology can be a standardised ontology. A user preference processor (303) provides a user preference profile for a first user and a concept processor (305) generates at least one additional concept for the multi-user ontology in response to the user preference profile. The additional concept is a predecessor concept for a group of concepts that have preferences in the user preference profile which meet a first criterion, such as a requirement that the concepts have sufficiently high preference values. An ontology processor (307) then generates a personalized ontology for the first user by adding the at least one additional concept to the multi-user ontology. An application processor (309) then proceeds to adapt the application for the first user in response to the personalised ontology.

### FIELD OF THE INVENTION

The invention relates to a method and apparatus for personalization of an application and in particular, but not exclusively, to personalisation of a content item search and retrieval system.

### BACKGROUND OF THE INVENTION

Personalisation and user adaptation of applications is becoming of increasing importance. Such personalization can for example include adapting a user interface, proposing recommendations, searching through content etc.

For example, in recent years, the availability and provision of multimedia and entertainment content has increased substantially. E.g., the number of available television and radio channels has grown considerably and the popularity of the Internet has provided new content distribution means.

Consequently, users are increasingly provided with a plethora of different types of content from different sources. In order to identify and select the desired content, the user must typically process large amounts of information which can be very cumbersome and impractical.

As another example, efficient search and retrieval systems is becoming increasingly important and significant research is focussed on personalising such systems such that the search and retrieval systems do not merely process a specific query but also takes user characteristics and preferences into account. For example, with the increasing volume of publicly available online text documents, it is impractical to manually sort through millions of online documents, blogs, articles or news to identify the documents of most interest. Thus, efficient search mechanisms may be applied that also consider user preferences when e.g. prioritising the search results. E.g. the text documents that match a specific query may be ranked according to the user's preferences.

In order to facilitate operation between different applications and data sources the concept of ontologies have been introduced to define how different data objects should be represented. Thus, an ontology is a data model that represents a set of concepts (or classes) within a domain and the relationships between those concepts. The concepts have associated properties (or attributes) that define characteristics associated with the concept. An ontology generally comprises a hierarchical arrangement of concepts connected by heritage links. A child concept corresponds to a further refinement of a parent concept and can specify further properties that only relate to a subset of the parent concept. An example of an ontology representing a “Restaurant” item is illustrated in FIG. 1 with further definition of one of the concepts “facilities” illustrated in FIG. 2. This allows a number of data objects describing different restaurants and e.g. generated/or provided by different sources to follow this data structure thereby ensuring that restaurant data objects from different sources are compatible with each other. Thus, an application processing such data objects can be designed on the basis of the ontology and without specifically considering the data objects themselves.

Ontologies can be based on taxonomies which attempt to classify a virtual or a concrete entity in a hierarchy of associated concepts. As another example, domain ontologies typically attempt to formalize the main concepts of a domain and are typically relatively flat. Domain ontologies tend not to attempt to classify individual instances but rather to represent the links/relations between different domain concepts.

The use of ontologies may facilitate and improve the processing of systems operating on diverse data objects provided by different sources and may in particular allow a number of different applications to use data objects from different sources provided the applications and data objects are based on the same ontology.

For example, in many information retrieval systems, the relevant documents are usually retrieved by simply matching keywords from a query with keywords from the searched documents. However, such an approach is suboptimal and tends to lead to only some relevant documents being identified (e.g. if related text documents use different terminology).

A possible solution that has recently been proposed is to use ontologies in information retrieval systems as a mean to refine a user query. For example, an ontology based approach may distinguish between the concept “jaguar” as the brand name for a car and “jaguar” as the term for the animal. In such systems, the query is matched against concepts of a domain ontology and related concepts of the domain ontology (for example a parent or child concept) may be considered to refine or expand the query. This allows more flexible search results as it is possible to exploit e.g. the relationships between concepts of the ontology to expand a query if there is no exact match for the original query. E.g., it is possible to exploit inheritance links between concepts to retrieve documents relating to more broad notions than the ones originally specified by the user.

The introduction of ontologies may thus provide significant advantages for an information search/retrieval system as the relations between concepts of the ontology can be used to improve the search process. However, as ontologies are inherently introduced to standardise and harmonise data objects from different sources, their introduction tends to reduce the level of personalisation of the specific application to which they are applied.

Taxonomy ontologies are typically defined and standardised by a group of experts. Therefore, they tend not to be adapted to the understanding of non-experts and tend not to correspond well to the general perception of a typical end-user. Domain ontologies are often simpler than taxonomy ontologies by typically do not provide enough classification capabilities to accurately reflect preferences and characteristics of individual users. Also, as they tend to be aimed at relations between different domains, they tend not to include many concepts suitable for more specific and detailed user characterisation.

Hence, an improved system of personalising an application based on the use of ontologies would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of personalising an application, the method comprising: providing a multi-user ontology for a plurality of users; providing a user preference profile for at least a first user of the plurality of users; generating at least one additional concept for the multi-user ontology in response to the user preference profile, the at least one additional concept being a predecessor concept for a group of concepts having preferences of the user preference profile meeting a first criterion; generating a personalized ontology for the first user by adding the at least one additional concept to the multi-user ontology; and adapting the application for the first user in response to the personalised ontology.

The invention may allow an improved and/or facilitated personalisation of a user application based on the use of ontologies. The invention may in many embodiments provide improved personalisation while maintaining the advantages of using ontologies. A flexible and/or low complexity personalisation may be achieved.

The multi-user ontology may specifically be a taxonomy and/or a domain ontology. The multi-user ontology may specifically be a standardised and/or general ontology.

According to another aspect of the invention there is provided apparatus for personalizing an application, the apparatus comprising: a unit for providing a multi-user ontology for a plurality of users; a unit for providing a user preference profile for at least a first user of the plurality of users; a unit for generating at least one additional concept for the multi-user ontology in response to the user preference profile, the at least one additional concept being a predecessor concept for a group of concepts having preferences of the user preference profile meeting a first criterion; a unit for generating a personalized ontology for the first user by adding the at least one additional concept to the multi-user ontology; and a unit for adapting the application for the first user in response to the personalised ontology.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a part of an ontology;

FIG. 2 illustrates an example a part of an ontology;

FIG. 3 illustrates an example of an apparatus for personalizing an application in accordance with some embodiments of the invention;

FIG. 4 illustrates an example of a method of personalizing an application in accordance with some embodiments of the invention;

FIG. 5 illustrates an example of an adaptation of an ontology in accordance with some embodiments of the invention;

FIG. 6 illustrates an example of a method of personalizing an ontology in accordance with some embodiments of the invention;

FIG. 7 illustrates an example of a subset of an ontology;

FIG. 8 illustrates an example of an ontology;

FIGS. 9 to 12 illustrate examples of conceptual graphs describing concepts of an ontology;

FIG. 13 illustrates an example of an operation between two conceptual graphs describing two concepts of an ontology in accordance with some embodiments of the invention;

FIG. 14 illustrates an example a conceptual graph resulting from the operation illustrated in FIG. 13; and

FIG. 15 illustrates an example of an ontology personalised in accordance with some embodiments of the invention.

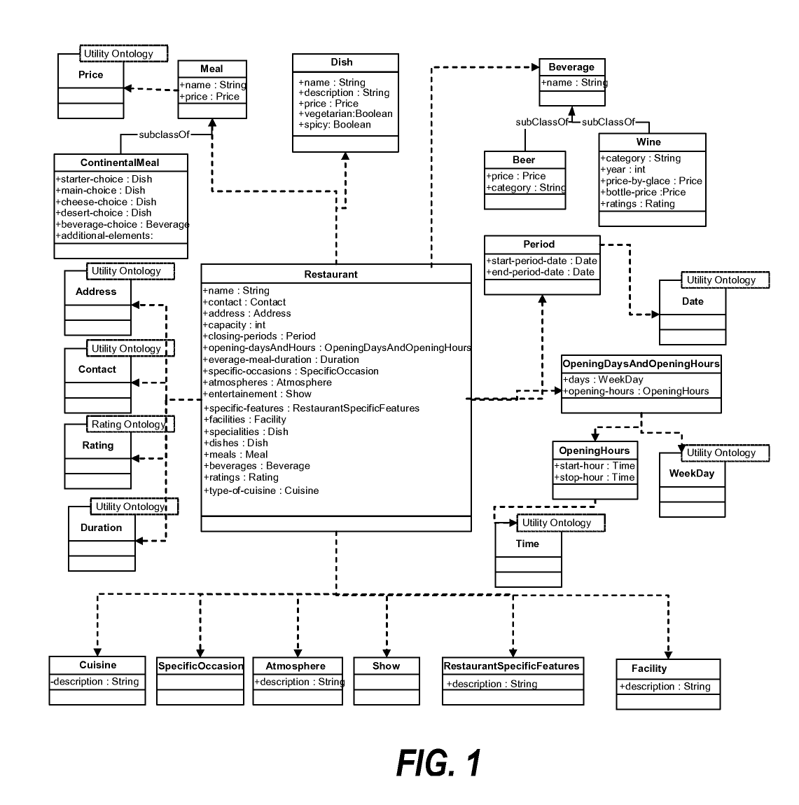

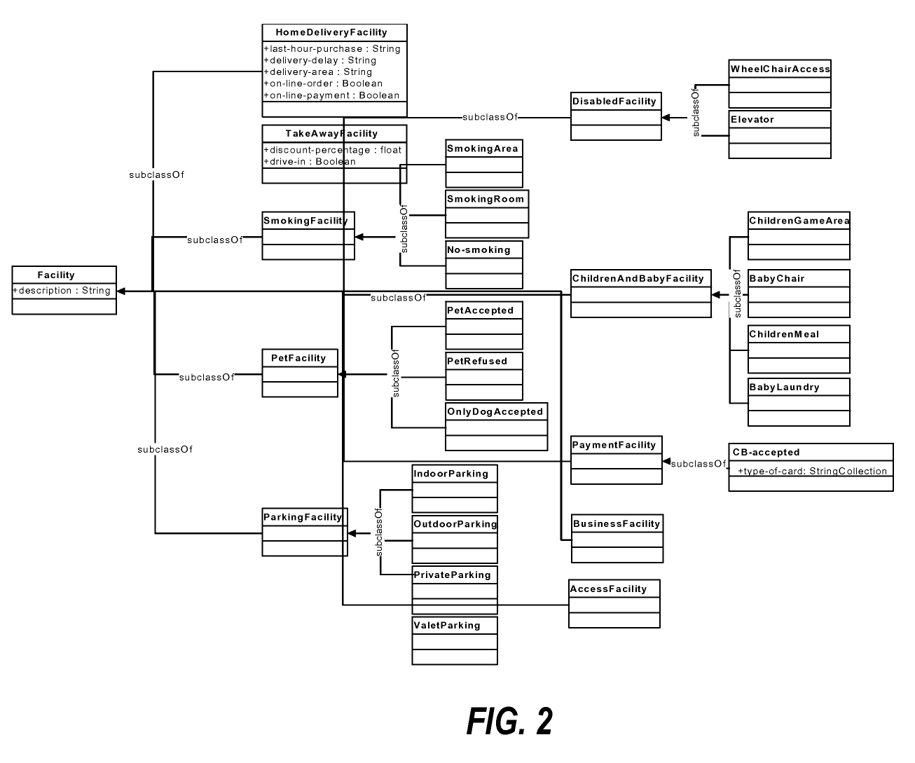

### DETAILED DESCRIPTION OF SOME EMBODIMENTS OF THE INVENTION

The following description focuses on embodiments of the invention applicable to a search and retrieval system for content items and in particular to a search and retrieval system for text documents. However, it will be appreciated that the invention is not limited to this application but may be applied to many other systems and applications.

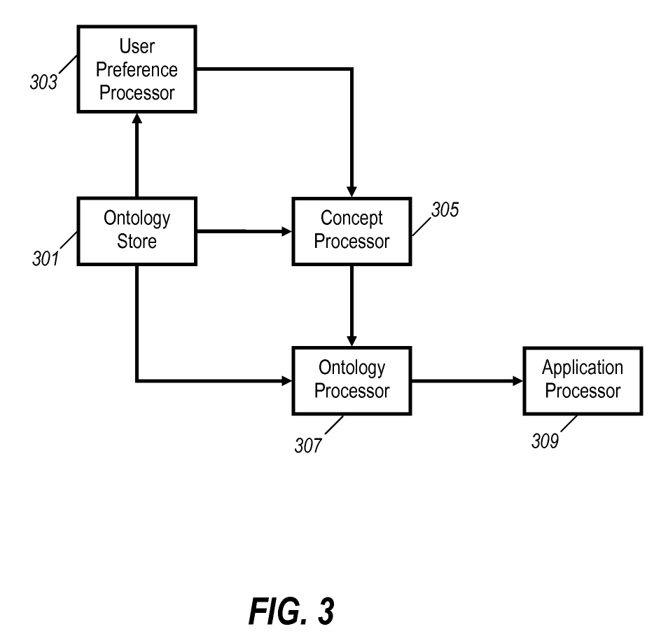

FIG. 3 illustrates an example of an apparatus for personalizing an application in accordance with some embodiments of the invention.

The apparatus comprises an ontology store which comprises a number of multi-user ontologies. The multi-user ontologies are identical for more than one user and may specifically be user independent ontologies. In the example, the multi user ontologies are standardised ontologies and are independent of any preferences or characteristics of any user associated with the use of an application using the ontologies.

The stored ontologies can specifically be standardised taxonomies or domain ontologies and may be provided, verified or validated by a suitable ontology standards body. As another example, the ontology may also follow a less formal standard, such as one resulting from an informal agreement within a community of experts. The ontology may specifically be standardised in the sense that it is published and publicly available to any application that would like to use it. Thus, the ontologies stored in the ontology store are standard ontologies that are used by a potentially large number of applications, data objects (including different collections and sources of data objects characterising content items such as e.g. text documents).

In the specific example, the apparatus is capable of executing an application that relies on data objects which are characterised in accordance with the standard ontologies stored in the ontology store. Specifically, the application is a text document search and retrieval application where the search is performed on metadata which for each text document is arranged in accordance with a standard ontology.

The ontology store 301 is coupled to a user preference processor 303 which comprises a user preference profile for a user of the application. In the example, the user preference profile is generated and updated by the apparatus itself. Specifically, the user preference profile is adapted in response to a user behaviour associated with the user application. In the example, the apparatus monitors the searches performed by the user and the user preferences are then updated depending on which of the retrieved text documents are selected by the user. As a simple example, the selection of a specific text document will result in the user preference value for all elements of the user preference profile that corresponds to a property of the selected text document being increased.

In the system, the user preference profile comprises user preferences for at least some concepts of the multi-user ontology. Specifically, a preference value may be stored for each concept of the multi-user ontology thereby providing a user preference profile which directly corresponds to the ontologies used by the application. This may substantially facilitate processing that involves the user preference profile, the application and the stored ontologies. For example, it may allow a facilitated and/or improved adaptation of the user preference profile in response to the user behaviour associated with the application and/or the generation of a personalised ontology as will be described in the following.

In the apparatus of FIG. 3, one or more personalised ontologies are generated based on the standardised ontologies and the user preferences. The operation of the application then depends on the personalised ontology resulting in a personalisation of the performed user application.

The ontology store 301 and the user preference processor 303 are coupled to a concept processor 305 which receives an ontology and a corresponding user preference profile and proceeds to generate at least one new concept for the ontology in response to the user preference profile.

The concept processor 305 specifically determines a group of concepts that have preference values in the user preference profile which meet a suitable criterion. The criterion can be that the preference values for the concepts exceed a given threshold resulting in the group of concepts being concepts that are of particular interest to the user.

The concept processor 305 then generates the additional concept as a predecessor/ancestor concept for the group of concepts, e.g. a parent concept having the group of concepts as child concepts may be generated. The properties of the additional concept are generated in response to the properties of the individual concepts in the group of concepts and can specifically be generated as the concepts which are common for all the concepts in the group of concepts. Thus, the concept processor 305 generates a more general concept representing common characteristics for a plurality of concepts that are of particular interest.

The concept processor 305 is coupled to an ontology processor 307 which generates a personalized ontology for the user by adding the additional concept determined by the concept processor 305 to the original standard multi-user ontology. Thus, an ontology which has an additional concept reflecting the specific user preferences of the individual user is generated. It will be appreciated that in a typical embodiment more than one additional concept may be introduced and that the personalised ontology may be continuously updated and adapted.

The ontology processor 307 is coupled to an application processor 309 which is operable to perform the application which in the specific example is a text document search and retrieval application.

In the example, the application performed by the application processor 309 directly uses the personalised ontology thereby automatically and inherently adapting or personalising itself in response to the personalised ontology. For example, a search query may be coordinated with the personalised ontology to generate a modified query. As a specific example, if a search query contains a value corresponding to a concept for which a personalised parent concept has been added, the search application may expand the search query to include one or more properties of the personalised parent concept.

In some examples, the adaptation or personalisation of the application may not be integrated with the execution of the application itself. For example a resource usage, display characteristic etc of the application may be changed by a separate process or processor.

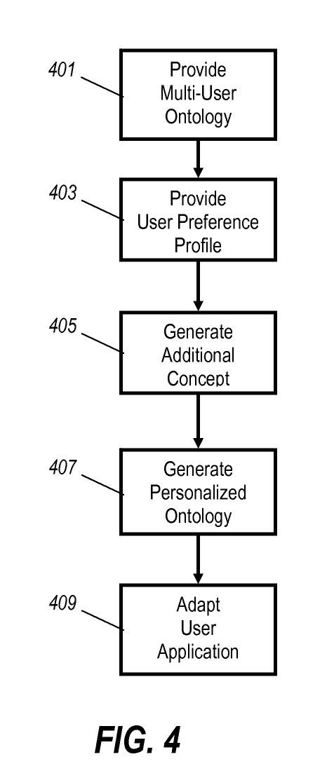

FIG. 4 illustrates a method of operation for the apparatus of FIG. 3.

The method starts in step 401 wherein the ontology store provides the multi-user ontology.

Step 401 is followed by step 403 wherein the user preference processor 303 provides a user preference profile for the user.

Step 403 is followed by step 405 wherein the concept processor 305 determines at least one additional concept for the multi-user ontology in response to the user preference profile. The at least one additional concept is determined as a predecessor concept for a group of concepts having preferences of the user preference profile meeting a first criterion.

Step 405 is followed by step 407 wherein the ontology processor 307 generates a personalized ontology for the user by adding the at least one additional concept to the multi-user ontology.

Step 407 is followed by step 409 wherein the application processor 309 adapts the user application in response to the personalised ontology.

The described system thus uses existing ontologies but adapts them dynamically and individually for each user so that new concepts which better reflect the specifics of the user are included. Thus, the system addresses the disadvantage that conventional ontologies are not complete or sufficiently precise and merely reflect the considerations of the originator rather than the individual user.

As an example, the apparatus of FIG. 3 may generate the personalised ontology based on the following basic algorithm:

### IF

concept c₁ has a preference value for the user above a given threshold and if c₁ is a sub-type of concept c; and
concept c₂ has a preference value for the user above a given threshold and if c₂ is a sub-type of concept c,

### THEN

an intermediate additional concept cᵥᵢᵣₜ is generated as a child of c and a parent of c₁ and c₂. The properties of cᵥᵢᵣₜ are determined as the properties which are common for c₁ and c₂.

Thus, an additional concept cᵥᵢᵣₜ is generated that represents an expanded preference that is more accurate than c but not as specific as c₁ and c₂. This concept may then be used to e.g. expand queries relating to c₁ or c₂ without needing to relate to the more general concept c which may include properties for which the user has low or no preference.

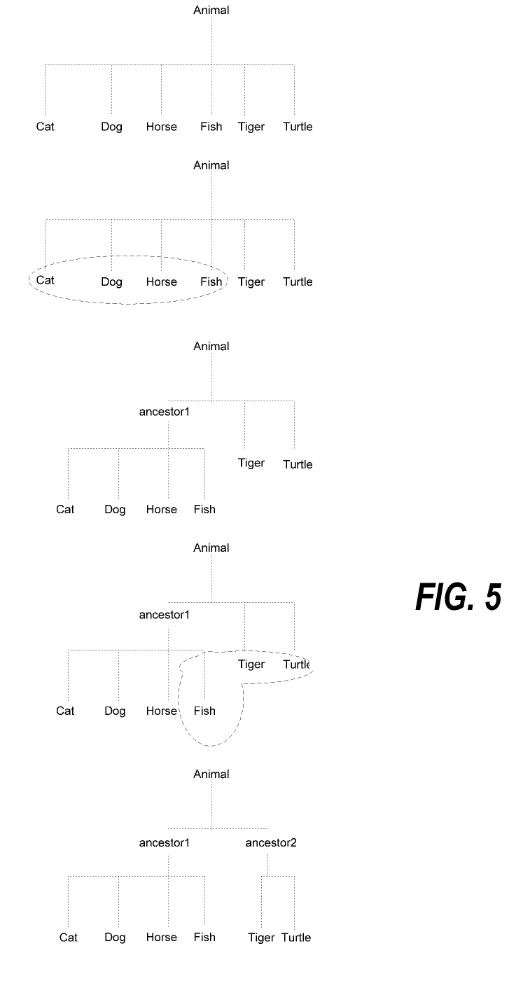

A simplified example of the generation and inclusion of an additional concept in accordance with this approach is shown in FIG. 5. For brevity and clarity, the example is illustrated for an extremely simple ontology which merely comprises a single parent concept with a number of child concepts (a more practical interpretation is to consider that FIG. 4 merely illustrates a small area of a much more complex ontology).

The standardised ontology thus only comprises the parent concept of “animal” with six child concepts “cat”, “dog”, “horse”, “fish”, “tiger”, “turtle”. The concept processor 305 determines that concepts “cat”, “dog”, “horse”, “fish” have a high preference value in the user preference profile (above the given threshold) whereas the preference values for the concepts “tiger”, “turtle” are low (below the given threshold). Furthermore, the concepts “cat”, “dog”, “horse” and “fish” are all children of the same concept “animal” and the concept processor 305 generates an intermediate concept “ancestor 1” and the ontology processor 307 inserts this in the ontology as a child of the concept “animal” and a parent of the concepts “cat”, “dog”, “horse”, “fish”. The properties of the new concept is set to the set of properties of the concepts “cat”, “dog”, “horse”, “fish” which are identical.

At a later stage the ontology may be further adapted. For example, the user preference profile may reflect a high preference value for (only) the concepts “fish”, “tiger” and “turtle”. However, only “tiger” and “turtle” have the same parent and accordingly a new concept “Ancestor 2” is created which represents only the concepts “tiger” and “turtle”. The concept “Ancestor 2” is included as a child of the concept “animal” and a parent of the concepts “tiger” and “turtle” and with the properties that correspond to the identical properties of the concepts “tiger” and “turtle”.

As the adaptation of the ontology is strongly dependent on the user's preferences, the personalised ontology will strongly reflect the user's preferences thereby allowing easy personalisation of applications using this ontology. Furthermore, the personalised ontology is inherently compatible with the standardised ontology as it merely differs in having added concepts.

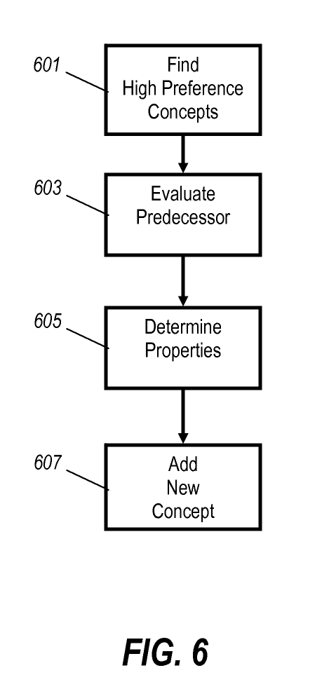

In the following a more detailed example of the generation of the additional concept will be described. The example is illustrated in FIG. 6

In step 601, the concept processor 305 proceeds to determine concepts that have a high preference value. In particular, as the user preference profile is organised according to the multi-user ontology, the concept processor 305 can simply select the concepts for which the user preference profile has a preference value above a given threshold.

Step 601 is followed by step 603 wherein the concept processor 305 proceeds to verify if all the selected concepts have the same predecessor. In the specific example, the group of concepts that may be used to generate a specific additional concept is selected with the requirement that the concepts have a preference value above a given threshold and have the same parent. It will be appreciated that dependent on the preference values this may result in a number of different groups of concepts which have sufficiently high preference values but have different parents. In such cases, each group may e.g. be processed individually as described in the following resulting in a plurality of additional concepts being introduced to the original user ontology or a single group may be selected (e.g. the one with the most concepts or the highest combined preference value) resulting in only the inclusion of one additional concept.

Thus, step 603 may generate a group of concepts which is based on their smallest common super-type (where the term super type refers to a predecessor concept which in the specific example is a parent concept but which more generally may be any predecessor/ancestor). Thus, the group may be defined by an ancestor concept c_{supertype} which is the smallest common super-type (the first common ancestor) of all concept in the group and the set of concepts itself {cₖ} where k is an index for the subtypes of type C_{supertype} (i.e. the predecessors) in the group.

Step 603 is followed by step 605 wherein the concept processor 305 proceeds to determine the properties for the at least one additional concept in response to properties of the group of concepts.

In the example, the concept processor 305 evaluates all properties of the concepts in the group to see if they are sufficiently similar. In the specific example, a similarity criterion is used which requires the concepts to be identical such that all properties which are present (and identical) in all the concepts of the group of concepts are included as properties for the new common additional concept. It will be appreciated that in other embodiments a less restrictive similarity criterion may be used which allows similar but non-identical properties can be selected. For example, two properties which share the same type and covers a common range of values can be considered sufficiently similar. For example, concept X has a property P1 of type age that can have values between 25 & 60; concept Y has another property P2 of type age and that can have values between 15 & 40. In this case P1 & P2 might be considered sufficiently similar because there exist a property P′ of type age and which has values both within P1 and P2 (typically values between 25 & 40).

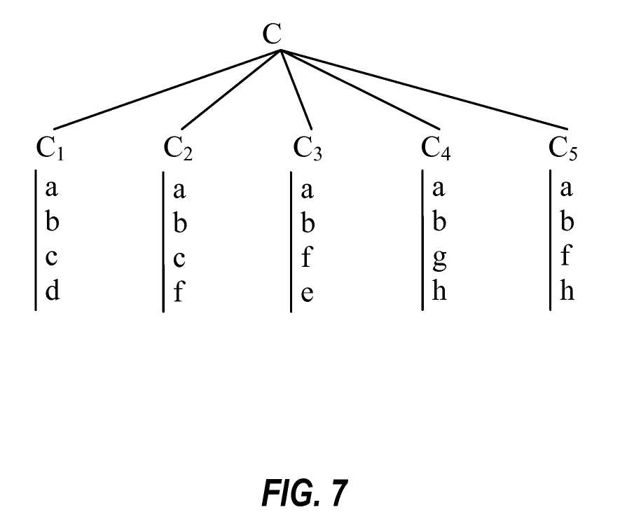

For example, FIG. 7 illustrates an example where a group of concepts C₁, C₂, C₃, C₄ and C₅ with high preference value and a common parent concept C have been identified. In addition, the parent concept C has a number of further child concepts (not shown) which do not have high preference values and which therefore are not considered for the new concept being generated.

Each of the high preference concepts have properties belonging to the set of properties: {a,b,c,d,e,f,g}. In the example, the concepts all contain the same properties {a,b} and accordingly an intermediate concept being a child of concept C and a parent of concepts C₁, C₂, C₃, C₄ and C₅ (but of not other children concepts of concept C) is generated having the properties of {a,b}.

Step 605 is followed by step 607 wherein the new concept is added to the ontology by the ontology processor 207. The new concept is added in between the common predecessor concept C and the group of concepts. In particular, the additional concept may be added as a child of concept C and a parent of the concepts C₁, C₂, C₃, C₄ and C₅.

It will be appreciated that in different scenarios the additional concept may be added in different locations of the ontology graph. For example, if the common predecessor is not a direct parent of the group of concepts, the additional concept may be added as a child of the common predecessor but not as a direct parent of the high preference concepts themselves.

As another example, even if the common concept is not a direct parent of the group of concepts, the new concept may be added as a parent of the group of concepts and a child of the common concept. Thus, in this example, the new concept is not introduced to a heritage link of the ontology graph but provides an alternative or additional link between the common concept and the group of concepts.

In the following two specific examples illustrating the benefits of the approach of the apparatus of FIG. 3 will be described.

In the first example, a user may have a specific interest in cats and a taxonomy ontology for cats is modified depending on the user's preferences. A standardized taxonomy for cats will be very specific and depend on the point of view of the expert generating the ontology and not the user who may be interested in properties that transcend the actual classification. In the described approach, the process of identifying commonalties between preferential concepts provides a detection of features in a concept that are of particular interest to the user. These can then be represented by a separate concept in the ontology.

For example, if the user is particularly interested in cats which have in common that they may have a tabby pattern, a taxonomy arranged according to breeds of cats will not be adequate for this particular end-user. Rather, it would have been preferential if an ontology based on cat patterns was used. In this case, the user could easily have found exactly the concepts corresponding to cats that he likes. As it is not possible to know in advance which criteria the individual user will apply, the current approach allows ontologies to be adapted by creating personal intermediary concepts, such as a concept that is common for all breeds that can include a tabby pattern. This concept is automatically detected and generated to reflect the specific user preferences.

As another example, a user may have specific interest in vehicles that have a powerful engine. In a typical ontology, this would be reflected in a number of different concepts including the concepts of ‘sport car vehicle’, ‘hyper sport bike’ etc. The acquisition process in such a scenario can be very time consuming as the vehicle ontology is not arranged in accordance with the specific characteristics of interest. The current approach would allow the system to generate a new concept that reflects this preference based on the detailed concepts of ‘sport car vehicle’, ‘hyper sport bike’ etc. For example, the apparatus can detect that preferred concepts relate to concepts wherein the power of the engine is more than 200 bhp and it can accordingly generate a new intermediary concept with this property. As a result, the ontology may be used to identify other vehicles that also have powerful engines.

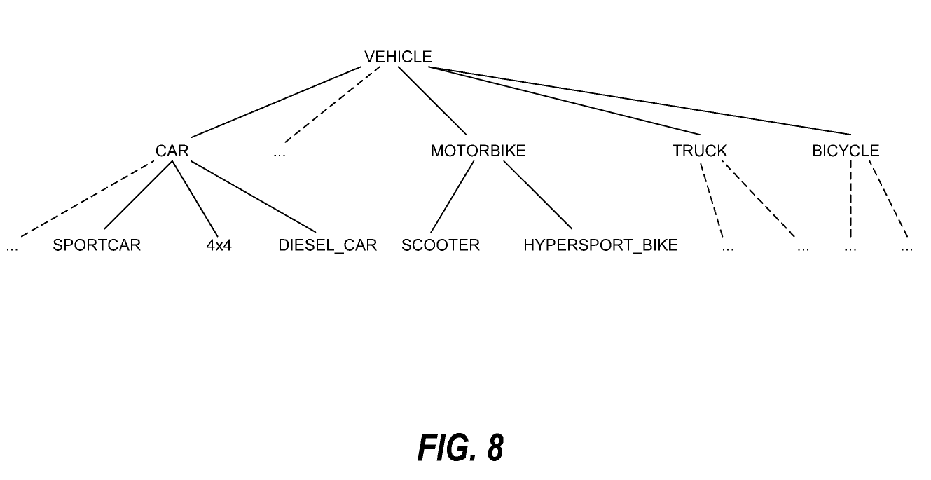

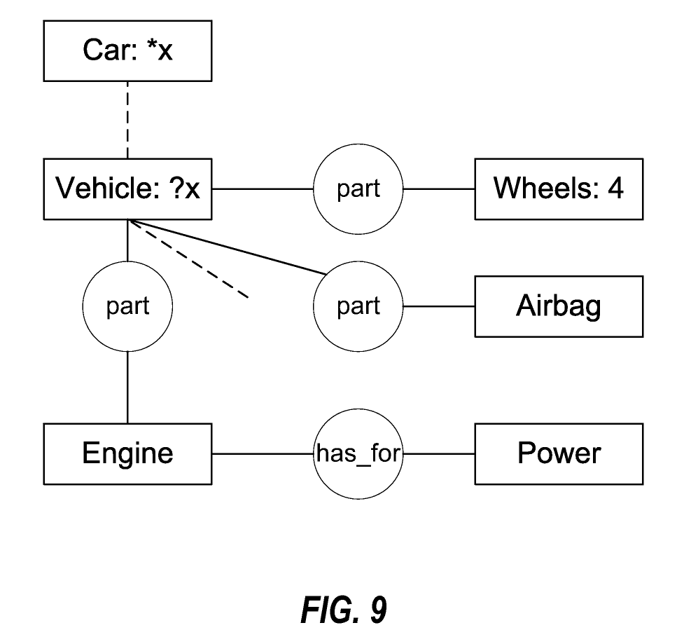

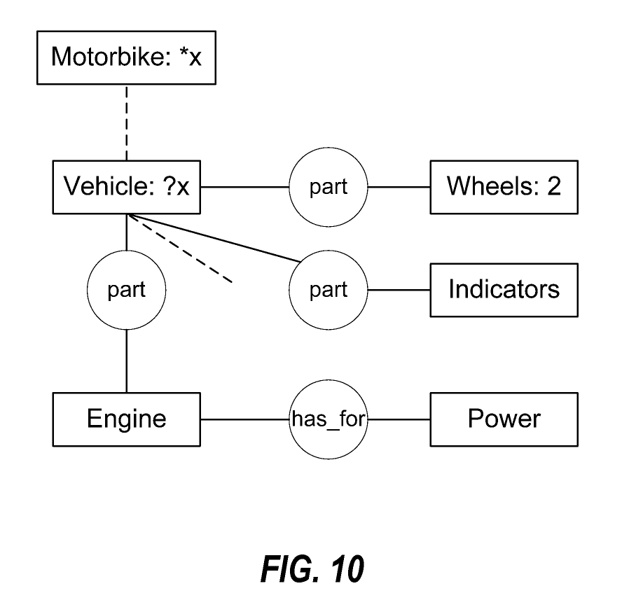

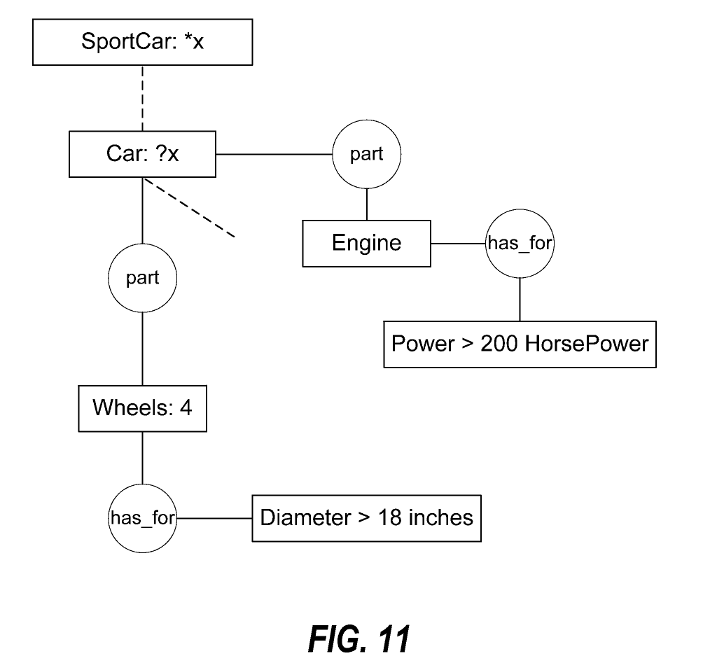

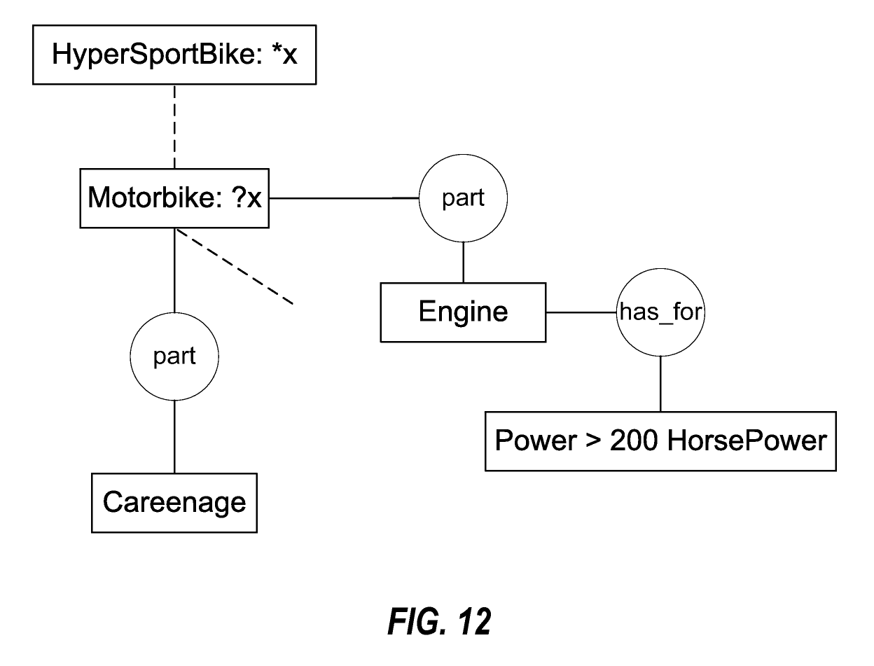

For example, (parts of) the original ontology may be as illustrated in FIG. 8. FIGS. 9 and 10 represent conceptual graphs describing the concept ‘Car’ and ‘Motorbike’ for the corresponding concepts of the ontology of FIG. 8. FIG. 11 illustrates an example of a description of the concept ‘sport car’ as a subtype of the concept ‘car’ and FIG. 12 illustrates an example of a description of the subconcept ‘hyper sport bike’ as a subtype of the concept ‘motorbike’.

In the specific example, the concepts ‘sport car’ and ‘hyper-sport bike’ are then further considered because the user preference profile indicates that these are of particular interest. Accordingly, the apparatus determines the smallest super-type (common predecessor concept) between the concepts ‘sport car’ and ‘hyper sport bike’. In the example, this concept is ‘vehicle’.

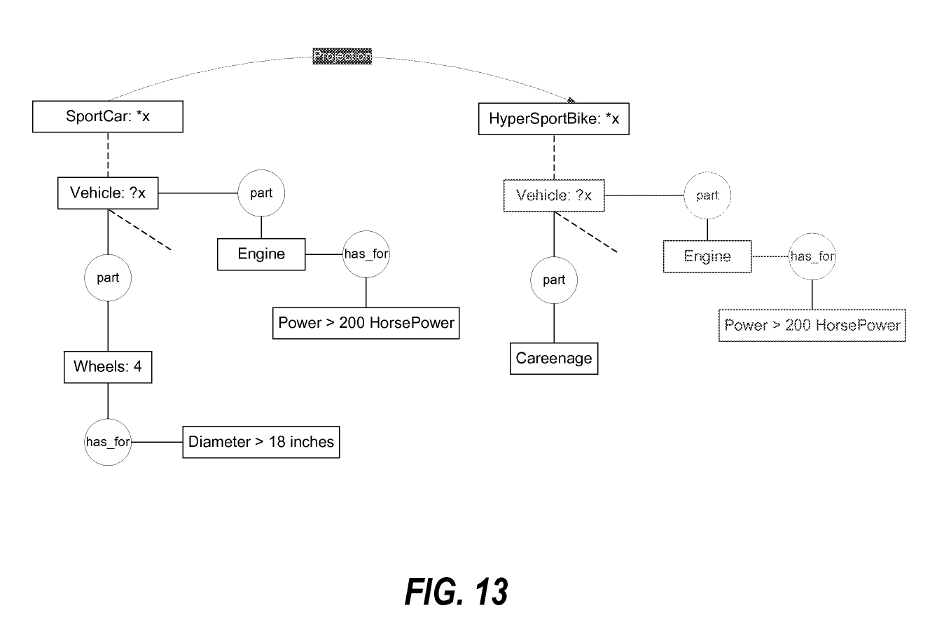

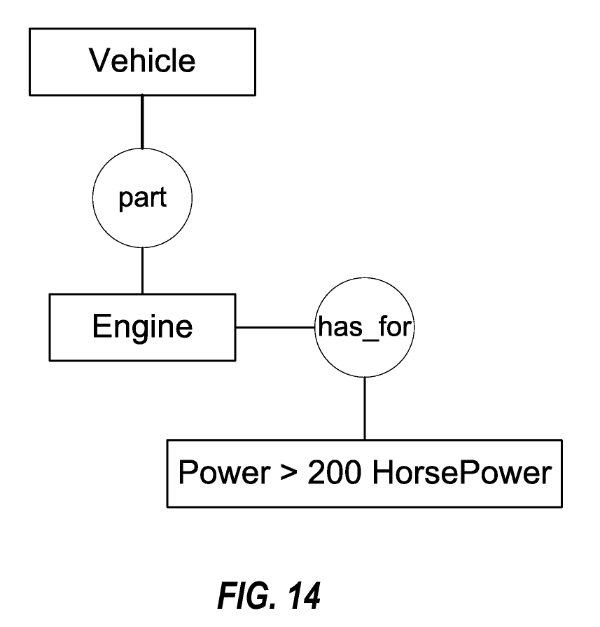

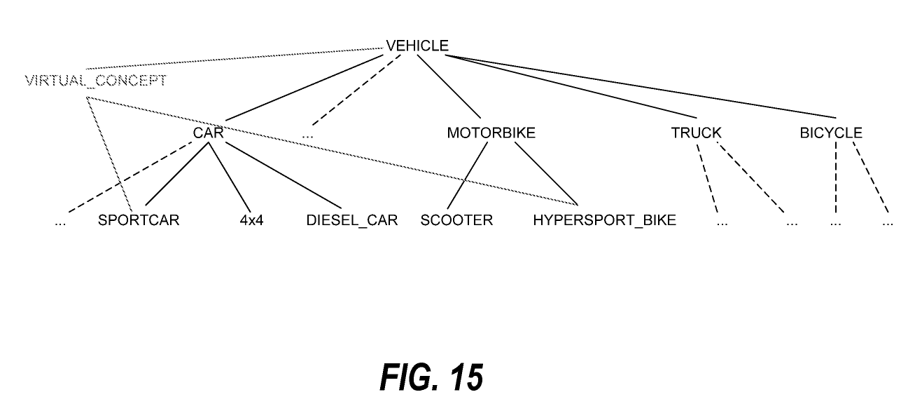

By expansion of the concept definition of ‘car’ and ‘motorbike’ respectively in the definition of ‘sport car’ and ‘hyper sport bike’, the conceptual graphs illustrated in FIG. 13 can be achieved. The conceptual graph operation of projection of the definition of ‘sport car’ on ‘hyper-sport bike’ on FIG. 13 results in the conceptual graph of FIG. 14 which defines a new concept with the common properties of the ‘sport car’ and ‘hyper-sport bike’ concepts. This new virtual concept is then introduced to the ontology of FIG. 8 to generate the personalized ontology of FIG. 15. Thus, this new concept describes sport vehicles in accordance with the user's preferences.

In the specific example, the application is a search application capable of searching a set of content items which specifically can be text documents, music clips, video clips etc. Each of the content items is described by meta-data arranged in accordance with at least one of the standardised ontologies stored in the ontology store 301.

In the example, the application can receive a search query which is in accordance with the standardised ontologies. For example, a user can include concepts and/or properties from different concepts in the search query. The application can then use the personalised ontology rather than the standardised ontology to search for suitable content.

Thus, the personalised ontology can be used for personalised content retrieval by using it in a similar way to the way the original ontology would have been used. For example, a query relating to concepts c₁ or c₂ will also include the additional personalised concept c containing these concepts.

This allows more accurate results to be generated in comparison to traditional methods. For example, a user interested in cats and dogs may not be interested in animals in general which would be considered for an ontology where the concepts ‘cat’ and ‘dog’ are direct sub-types of the concept ‘animal’. The current approach provides for the generation of an intermediate category which includes the common properties of the concepts ‘cat’ and ‘dog’ thereby allowing the search to identify other animals which are similar (e.g. other pets) while still avoiding that all animals are identified by the search.

It will be appreciated that in a search and retrieval system, the preferences may be determined in response to a search frequency for individual concepts and that the selection of the group of concepts for generating an additional concept can be determined from how often the concepts are included in user searches.

As another example, the application may be a presentation algorithm which is arranged to present the user preferences of the user preference profile. The presentation of the user preferences may then be adjusted in response to the personalised ontology and specifically a preference value may be presented for the additional personalised concepts as well as or instead of some of the standardised concepts. The preference value for a personalised intermediate concept may e.g. be determined as the sum or average of the preference values of the child concepts of the personalised concept.

For example, a user preference profile may be very complex and include many preference values associated with many concepts (corresponding to a complex category). Thus, presenting all these preference values to a user may be confusing and unclear to the user. However, merely presenting preference values for the higher hierarchical layers may be too general and not provide enough specific information. In such an example, the application may present a preference value for one or more personalised concepts and not present any preference values for the child concepts of the personalised concepts. This may allow an improved presentation of preferences which provide a better trade-off between the conflicting preferences of providing easy to understand information and detailed information.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of personalising an application, the method comprising:
providing a multi-user ontology for a plurality of users;
providing a user preference profile for at least a first user of the plurality of users;
generating at least one additional concept for the multi-user ontology in response to the user preference profile, the at least one additional concept being a predecessor concept for a group of concepts having preferences of the user preference profile meeting a first criterion;
generating a personalized ontology for the first user by adding the at least one additional concept to the multi-user ontology; and
adapting the application for the first user in response to the personalised ontology.

2. The method of claim 1 further comprising the step of determining properties for the at least one additional concept in response to properties of the group of concepts.

3. The method of claim 2 wherein the step of determining properties for the at least one additional concept comprises determining the properties in response to a set of properties of the group of concepts meeting a similarity criterion.

4. The method of claim 2 wherein the similarity criterion comprises a requirement that the properties are identical for all concepts of the group of concepts.

5. The method of claim 1 wherein the first criterion comprises a requirement that a preference value for each concept of the group of concepts exceeds a threshold.

6. The method of claim 1 wherein the first criterion comprises a requirement that all concepts of the group of concepts have a common predecessor.

7. The method of claim 1 further comprising:
determining a common predecessor concept for the group of concepts; and
wherein the step of generating the personalized ontology comprises including the at least one additional concept as an intermediate concept between the common predecessor and the group of concepts.

8. The method of claim 7 wherein the common predecessor concept is a parent concept of each concept of the group of concepts.

9. The method of claim 7 wherein the common predecessor concept is not a parent concept of each concept of the group of concepts.

10. The method of claim 1 wherein the at least one additional concept is added as a parent of each concept of the group of concepts.

11. The method of claim 1 wherein the application is operable to present the user preference profile.

12. The method of claim 11 wherein the step of adapting the application comprises presenting a preference value for the at least one additional concept and not presenting any preference value for any concept of the group of concepts.

13. The method of claim 1 wherein the application is a search application capable of searching a set of content items, each content item having associated descriptive data in accordance with the multi-user ontology.

14. The method of claim 13 wherein step of adapting the application comprises modifying a search query in response to the personalized ontology.

15. The method of claim 13 wherein the first criterion comprises a requirement that a search frequency for concepts of the group of concepts exceeds a threshold.

16. The method of claim 1 further comprising the step of adapting the user preference profile in response to user behaviour associated with the application.

17. The method of claim 1 wherein the user preference profile comprises user preferences for at least some concepts of the multi-user ontology.

18. An apparatus for personalizing an application, the apparatus comprising:
a unit for providing a multi-user ontology for a plurality of users;
a unit for providing a user preference profile for at least a first user of the plurality of users;
a unit for generating at least one additional concept for the multi-user ontology in response to the user preference profile, the at least one additional concept being a predecessor concept for a group of concepts having preferences of the user preference profile meeting a first criterion;
a unit for generating a personalized ontology for the first user by adding the at least one additional concept to the multi-user ontology; and
a unit for adapting the application for the first user in response to the personalised ontology.
